(19) United States
(12) Patent Application Publication
(10) Pub. No.: US 2012/0193261 A1
(43) Pub. Date: Aug. 2, 2012

(54) FOLDING IMPACT RESISTANT PACKAGING CONTAINER INSERT

(76) Inventor: Moshe Begim, Torrance, CA (US)

(21) Appl. No.: 13/250,821

(22) Filed: Sep. 30, 2011

Related U.S. Application Data
(60) Provisional application No. 61/436,603, filed on Jan. 27, 2011.

(51) Int. Cl. B65D 81/02; B31B 3/00

(52) U.S. Cl. 206/521; 493/162

(57) ABSTRACT

A folding insert formed of a single sheet of deformable material includes two side members attached to opposing sides of a spanning member, the side members adapted to fold relative the spanning member and connect by a latch apart from the spanning member. When moved together to be adjoining, the side members define a holder for an impact sensitive item. The assembled folding insert also includes handle portions for grasping the insert, and recessed areas adjacent the impact sensitive item for extraction. Advantageously, a multiplicity of the folding inserts may be stacked prior to use.

This application claims the benefit of the filing date of provisional application No. 61/436,603, filed on Jan. 27, 2011.

### BACKGROUND

Packaging and package inserts for protecting impact sensitive items are known in the art. Although various materials and apparatus are known for cushioning products, conforming inserts, including vacuum-formed plastic inserts are one preferred type of construction. These types of inserts have deformable resiliency and reduce waste from fillers such as polystyrene or other materials used in bulk. Like polystyrene, vacuum-formed plastics can be easily formed into desired shapes conforming to specific products.

One drawback to formed plastic, particularly vacuum-formed plastic package inserts, is they must be formed into a desired shape, then shipped to a separate location for use. Shipping packaging inserts is undesirable for a variety of reasons, including shipping costs and lost production time. Crating and shipping large volumes of packaging inserts can also be logistically complicated. Thus a need exists for a package insert which can be easily and inexpensively manufactured, for instance vacuum-formed from a planar sheet of plastic material, and which is able to stack together in a compact configuration enabling large volume storage and shipping, but which can be folded into a shape suitable for providing maximum protection to impact sensitive products.

### SUMMARY

A folding impact resistant packaging container insert is disclosed. The packaging insert has two side members and a spanning member. The spanning member is substantially planar, and the side members are each affixed to the spanning member on opposite sides. In one embodiment, the side members are affixed to the spanning member by living hinges, relying on the pliable nature of the insert material to allow the side members to fold independently relative to the spanning member. In this manner, the side members may lay flat in substantially the same plane as the spanning member, or be folded upward toward each other until they meet, adjoining above the spanning member. Prior to use, with the side members in a flat, unfolded configuration, multiple inserts may be stacked one atop the other in a nested configuration to conserve space.

It is anticipated that the side members may be formed, including vacuum-formed, such that each side member comprises a pocket consisting of a portion of a holder shaped to hold an impact sensitive item. In one embodiment, the side members may be vacuum-formed into complimentary mirror-image shapes, so that each side member is complimentary in profile and comprises one half of the holder. It is also anticipated that a substantial portion of each side member may present complimentary faces abutting each other in one embodiment, or in the alternative, in an adjoining configuration. By presenting substantially planar complimentary faces, the side members, when abutting each other, add resiliency to the folding insert, which may be made of a resiliently deformable material.

In order to present an efficient method of grasping an impact sensitive item secured by the folding insert and contained in a packaging container, and to assist in manipulating the folding insert when inserting or removing it from a packaging container, the two side members are provided with handle portions. In an exemplary embodiment, the handle portions are vacuum-formed so that when the side members are adjacent each other, one or more handle portions is formed adjacent the holding portion of the folding insert.

In addition to the handle portions, it is contemplated that the holding portion of the folding insert may not extend continuously around the impact sensitive item being held. Rather, a series of recessed areas may be formed adjacent the holding portion, creating a space between the holding portion of the folding insert and the impact sensitive item. One advantage to the inclusion of such recessed areas is the inclusion of access for a user's fingers and provide an additional surface against the packaging container adapted to deform when the packaging container bearing the folding insert encounters a shock or impact. In this manner, the recessed areas serve an additional shock absorbing purpose by presenting feet against the packaging container in a pressure fit similar to the feet of the spanning member.

In order to preserve the two side members in an assembled shape to properly hold an impact sensitive item, a latch is provided. In one embodiment, the latch is an interference fit connector molded into the folding insert. The advantages of using an interference fit connector include the ability to vacuum-form the latch along with other parts of the folding insert, particularly by virtue of the resilient nature of the plastic or similar starting material.

Another reason for the inclusion of the latch is to hold the folding insert in a holding position before insertion into a packaging container. Although the folding insert should be sized so that when confined within a packaging container, the sides of the packaging container hold the side members of the folding insert together. it may be advantageous to have the side members held together outside the packaging container, for instance during assembly of the impact sensitive item, folding insert, and packaging container.

The spanning member affixed to the two side members is substantially planar and adapted to engage a wall of the packaging container adjacent a wall engaged by a side member. In an exemplary embodiment, the spanning member has at least one pair of opposing side edges, and the side members are connected to those edges. It is anticipated that in a vacuum-formed embodiment of the folding insert, the spanning member and side members will all be formed of one resilient sheet of plastic or plastic-like material. By vacuum-forming the spanning member and side members from a single sheet of material, the side members are able to fold relative to the spanning member by virtue of a living hinge. In one embodiment, the living hinge is substantially accordion-shaped, adding to its flexibility.

When the side members are folded into a position forming the holder, and connected by the latch, the folding insert is shaped for insertion into a packaging container. The portions of the side members forming the recessed areas present feet engaging the inside of the packaging container sufficiently to form an interference fit, which may, in some embodiments, slightly deform the recessed areas. In this manner, the folding insert is able to maintain sufficient rigidity to hold the impact sensitive item in position and avoid contact between the item and the packaging container walls. Additionally, in one embodiment, the spanning member is formed to have feet so that the entire substantially planar spanning member is offset from the packaging container.

### BRIEF DESCRIPTION OF THE FIGURES

FIG. 1 is a perspective view of an impact resistant folding insert configured for insertion into a packaging container.

FIG. 2 is a top perspective view of an impact resistant folding insert prior to configuration for insertion into a packaging container.

FIG. 3 is a bottom perspective view of an impact resistant folding insert prior to configuration for insertion into a packaging container.

FIG. 4 is a side view of an impact resistant folding insert.

FIG. 5 is a perspective view of an impact resistant folding insert holding an impact sensitive item in a packaging container.

FIG. 6 is a perspective view of a second impact resistant folding insert being inserted into a packaging container so that two impact resistant folding inserts hold an impact sensitive item.

FIG. 7 is a cut-away view of two impact resistant folding inserts holding an impact sensitive item in a packaging container.

FIG. 8 is a side view of several impact resistant folding inserts stacked together in a nested configuration.

FIG. 9 is a perspective view of an alternative embodiment of an impact resistant folding insert adapted to hold a smaller item.

### DESCRIPTION

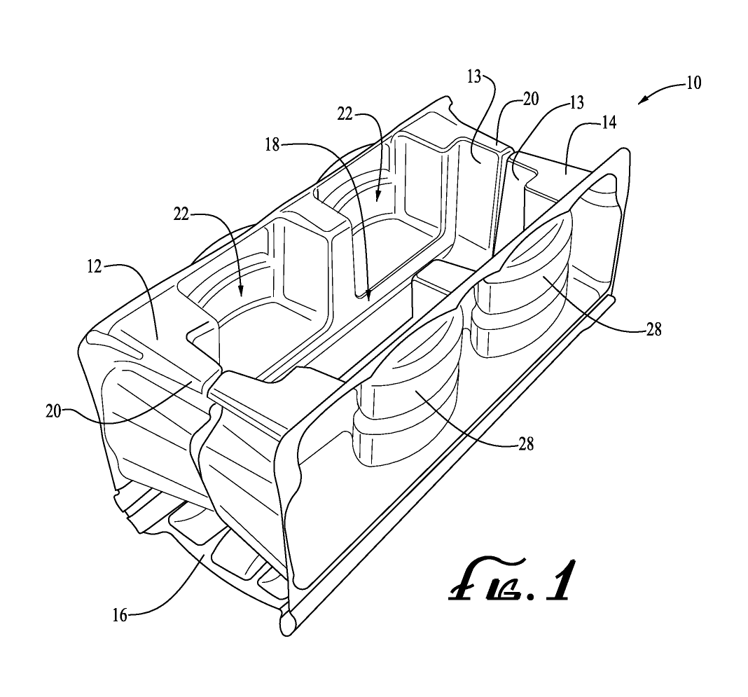

Referring to FIG. 1, a folding insert 10 for protecting an impact sensitive item (not shown) in a packaging container (not shown) is shown. The folding insert 10 comprises a first: side member 12 having a pocket 13, a second side member 14 having a pocket 13, and a spanning member 16. In the configuration shown in FIG. 1, the folding insert 10 is ready for insertion into a packaging container (not shown). By bringing the pockets 13 of the first side member 12 and second side member 14 together, a holder 18 is formed. The holder 18 is a predetermined shape conforming to the shape of an impact sensitive item (not shown) to be held by the folding insert 10.

Still referring to FIG. 1, two handle portions 20 are shown, also formed by the adjoining of the first side member 12 and second side member 14. The handle portions 20 are designed so that a user can pull the folding insert 10 out of a packaging container easily. It is anticipated the handle portions 20 may be necessary due to the folding insert's 10 pressure fit in a packaging container. In addition to the handle portions 20, several recessed areas 22 are disposed adjacent the holder 18. The recessed areas 22 enable a user to easily grasp the impact sensitive item and remove it from the packaging container.

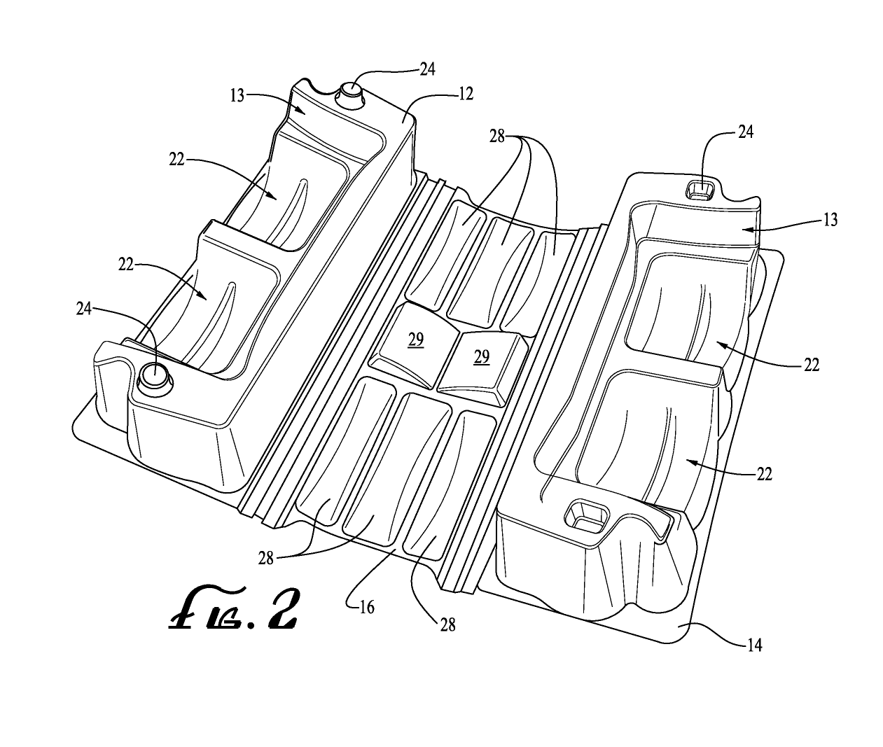

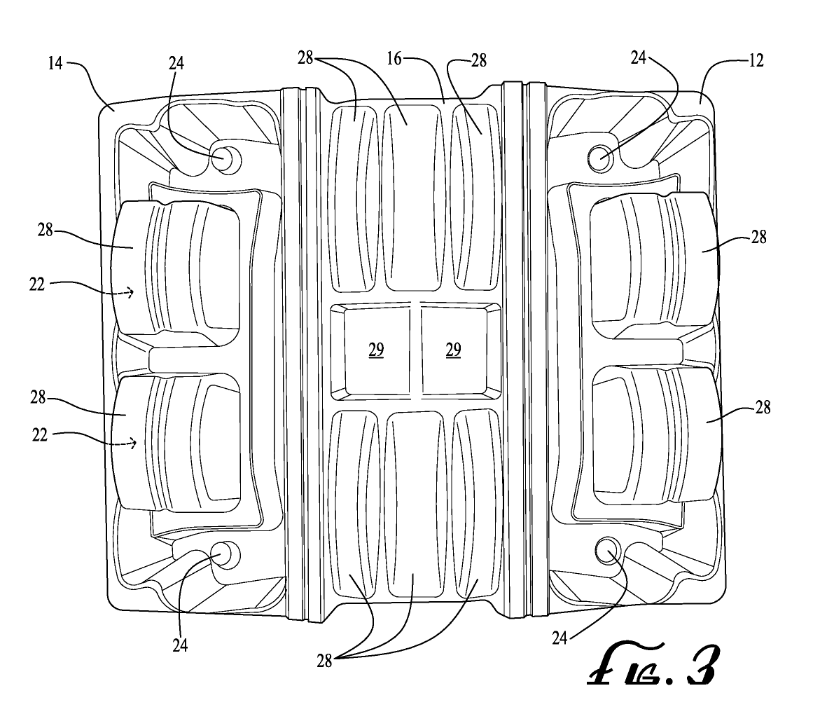

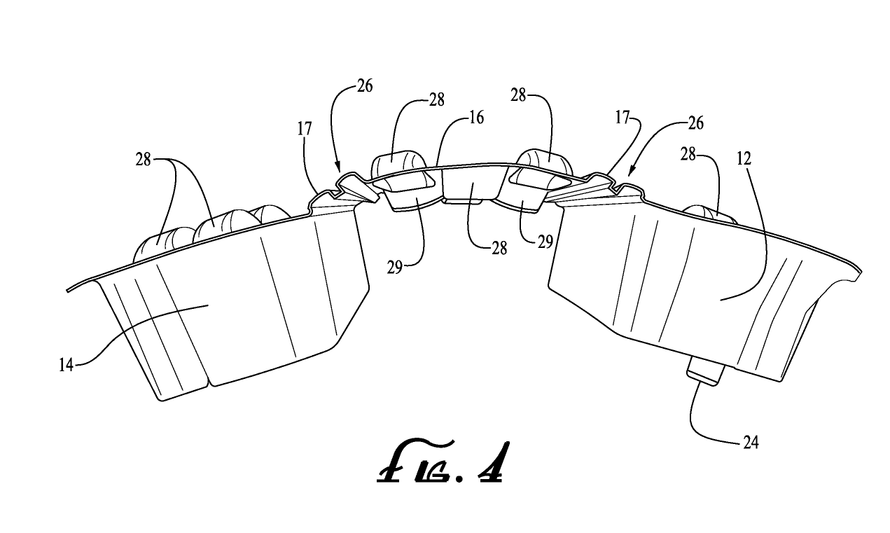

Referring to FIGS. 2, 3 and 4, an impact resistant folding insert 10 is shown in an open configuration. In these views, the folding insert 10 is substantially flat, corresponding roughly to an item-shaped die used to vacuum-form the folding insert 10. In this view, in addition to the recessed areas 22 on the first side member 12 and second side member 14, the latch 24 is shown. In one embodiment, the latch 24 comprises a male/female interference fit connector, created in the vacuum-forming process along with the rest of the folding insert 10.

In one embodiment, the first side member 12 and second side member 14 are connected to the spanning member 16 by a living hinge 17. In another exemplary embodiment the living hinges 17 comprise accordion folds 26, having spring-like resistance to shock when the folding insert 10 is in use. The spanning member 16 may include feet 28 which help cushion the spanning member 16 against shock and ensure the spanning member 16 doesn't simply rest against the inner surface of the packaging container (not shown). The spanning member 16 may also include supports 29 which act as stops for the side members 12, 14, when the folding insert 10 is in a folded configuration.

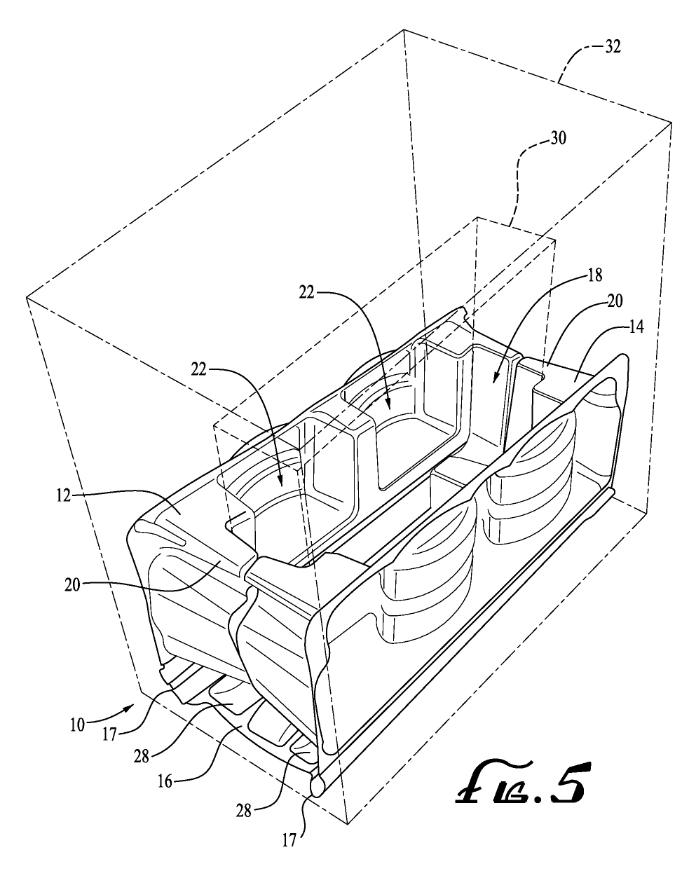

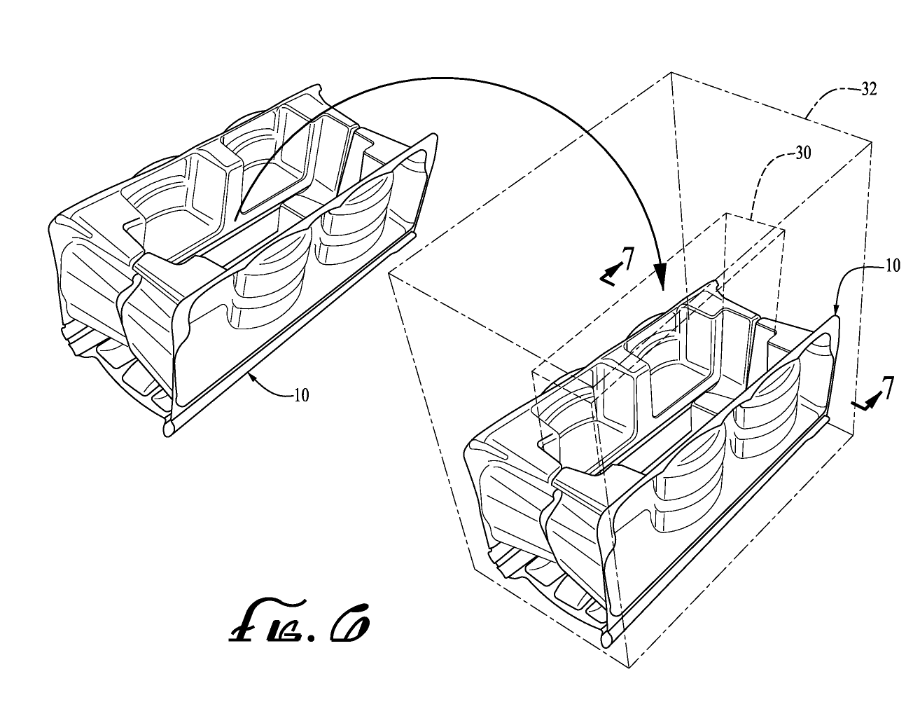

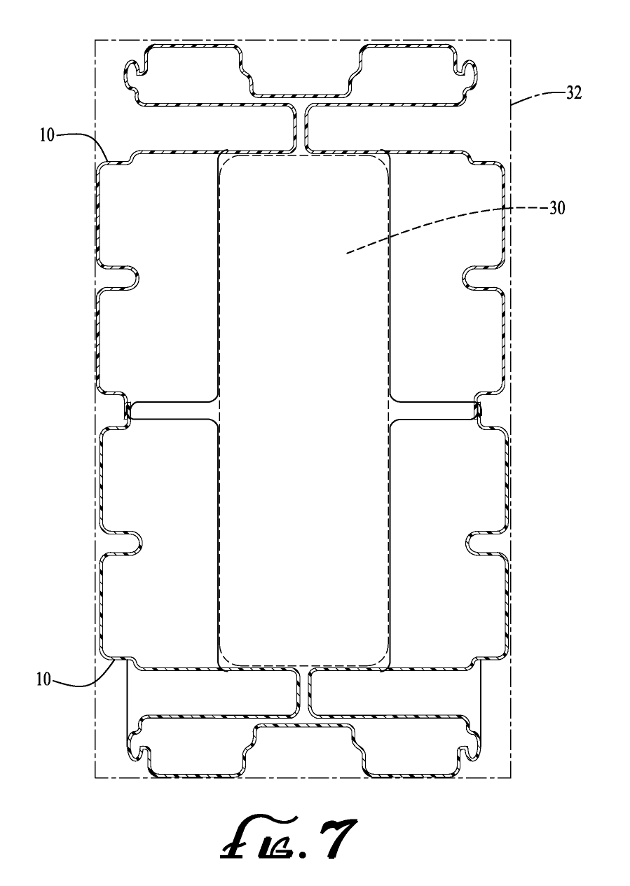

Referring to FIGS. 5, 6, and 7, the folding insert 10 is shown installed in a packaging container 32 protecting an impact sensitive item 30. Referring specifically to FIG. 5, the folding insert 10 is inserted into a packaging container 32 so that the spanning member 16, including the feet 28 and living hinges 17, engage the packaging container 32 bottom. The first side member 12 and the second side member 14 extend upward from the spanning member 16. The side members 12, 14 together form a holder 18 for the impact sensitive item 30, and form handle portions 20 and recessed areas 22. Referring to FIG. 6, a perspective view of a packaging system is shown, wherein after placing an impact sensitive item 30 into a packaging container 32, a user places a second folding insert 10 over the item 30 to sandwich the impact sensitive item 30 in the packaging container 32. FIG. 7 is a cutaway view of the configuration shown in FIG. 6 when fully incorporated into a closed packaging container 32.

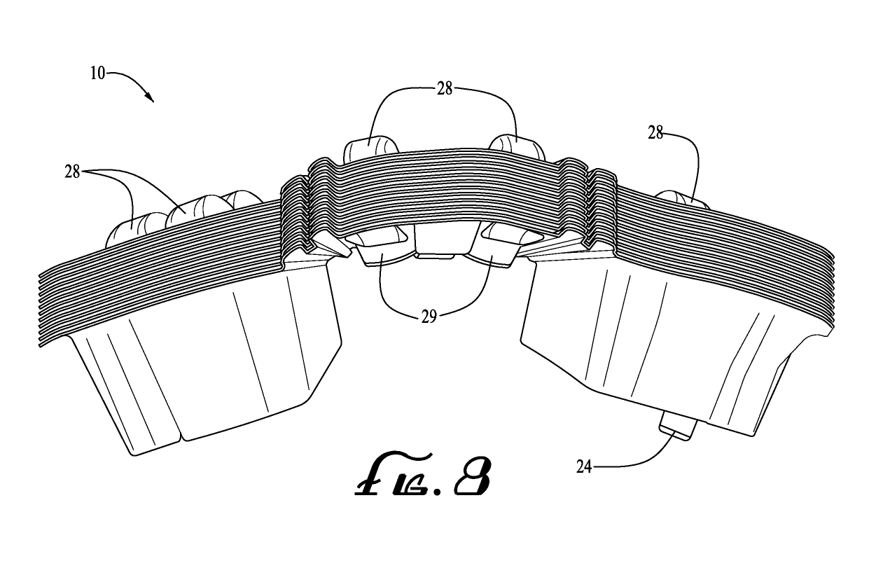

Referring to FIG. 8, a series of impact resistant folding inserts 10 are shown in a substantially flat, unfolded configuration. By forming the folding insert 10 from a single thin sheet of flexible material, for example vacuum formed plastic, multiple folding inserts may be stacked closely together in a nested configuration, conserving space for shipping and storage.

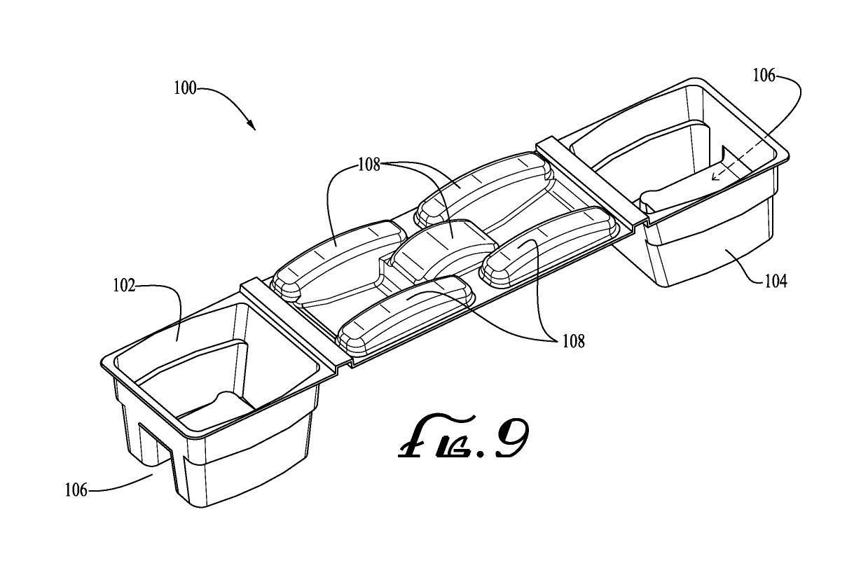

Referring to FIG. 9, one alternative embodiment of the folding insert 100 is shown in an unfolded configuration. In this embodiment, the folding insert 100 is adapted for holding a smaller impact sensitive item (not shown), and lacks the recessed areas (ref no. 22 in FIGS. 1-3, 5). Also in this embodiment, the side members 102, 104, have no latching mechanism (ref no. 24, FIGS. 2-4), as the packaging container (ref. no. 32, FIGS. 5, 6) into which the folding insert 100 is placed will preserve the side members 102, 104 in an adjoining configuration. Similar to other embodiments, the folding insert 100 has a holder 106 and feet 108.

The structure of the folding insert 10, 100 having been shown and described, use of the apparatus will now be explained.

In order to manufacture the folding insert 10, 100, a unitary piece of resiliently deformable material, such as plastic, is vacuum formed to comprise three principal adjoining parts: a first side member 12, a second side member 14, and a spanning member 16. The side members 12, 14 are connected on opposite sides of the spanning member 16 in a manner allowing them to be folded together to form a folding insert 10 for holding an impact sensitive item 30.

Various aspects of the folding insert 10 add to its impact resistant nature. The side members 12, 14 comprise recessed areas 22 adjacent a holder 18 area, the recessed areas 22 comprise feet 28 adapted to engage a packaging container 32, maintaining the holder 18 area inside, but away from the packaging container 32. The spanning member 16 comprises feet 28 to prevent the substantially planar spanning member 16 from pressing flat against the packaging container 32. The connection area between the side members 12, 14 and spanning member 16 comprise accordion folded living hinges 17 helping to ensure a spring action allowing the folding insert 10 to further absorb shock.

In order to assemble the folding insert 10, a user folds the side members 12, 14 into position, connecting them in a substantially adjoining configuration above the spanning member 16. By pressing on the latch 24, the side members 12, 14 are held in place. An impact sensitive item 30 may then be placed in the holder region 18 of the folding insert 10, and the folding insert 10 and impact sensitive item 30 may be placed in a packaging container 32. A second folding insert 10 may then be assembled and placed opposite the impact sensitive item 30, and the packaging container 32 closed over the second folding insert 10.

The alternate embodiment of the folding insert 100 is used in substantially the same way, except that the folding insert 100 is first inserted into a packaging container (not shown) and in the process the side members 102, 104 are folded into and held in position due to an interference fit within the packaging container. Due to the folding insert's 100 small size, the latch 24 and recessed areas 22 may be omitted from this embodiment.

While the apparatus and method have been described in detail with reference to specific embodiments thereof, it will be apparent to one skilled in the art that various changes and modifications can be made therein without departing from the spirit and scope thereof. Thus, it is intended that the present description cover the modifications and variations of the apparatus and method provided they come within the scope of the appended claims and their equivalents.

What is claimed is:

1. A folding insert for protecting an impact sensitive item in a packaging container comprising:
a first side member having a pocket;
a second side member having a pocket; and
a spanning member foldably connected between the first side member and the second side member;
wherein the folding insert may be folded such that the first side member and the second side member are brought into an adjoining position such that the pockets form a holder for the impact sensitive item.

2. The folding insert of claim 1 further comprising a latch for releasably connecting the first side member and the second side member in the adjoining position.

3. The folding insert of claim 2 wherein the latch connects via an interference fit.

4. The folding insert of claim 1 wherein, when the first side member and the second side member are folded into the adjoining position, the holder is substantially separated from the spanning member.

5. The folding insert of claim 1 wherein the folding insert is a resiliently deformable material.

6. The folding insert of claim 1 wherein the folding insert is configured such that when the first side member and the second side member are folded into the adjoining position a handle portion is formed.

7. The folding insert of claim 1 wherein the first side member and the second side member each include a recessed area for finger access.

8. The folding insert of claim 1 wherein the first side member and the second side member each have a foot adapted to engage the packaging container in a pressure fit.

9. The folding insert of claim 1 wherein the first side member and the second side member are substantially mirror images of one another.

10. The folding insert of claim 1 wherein the first side member and the second side member are connected to the spanning member by living hinges.

11. The folding insert of claim 10 wherein the living hinges are accordion shaped.

12. The folding insert of claim 1 wherein the spanning member includes a foot adapted to contact the packaging container.

13. The folding insert of claim 1 wherein the folding insert is a single unitary piece of material.

14. The folding insert of claim 1 wherein, when the first side member and the second side member are not in the adjoining position, a multiplicity of the folding inserts may be stacked in a compact nested configuration.

15. A packaging system for holding an impact sensitive item comprising:
a first folding insert made of a single piece of deformable material, having a first side member, a second side member, and a spanning member therebetween connected by living hinges, and wherein the first side member and the second side member, when brought together, form a holder for a portion of the impact sensitive item;
a second folding insert substantially identical to the first folding insert; and
wherein the first folding insert and second folding insert oppose each other, protecting the impact sensitive item.

16. A method of protecting an impact sensitive item comprising the steps of:
obtaining a substantially planar piece of deformable material;
forming portions of the deformable material into complimentary shaped side members;
forming a spanning member between the side members, such that the spanning member is connected between the side members by living hinges;
forming a latch for connecting together the side members;
folding the side members together via the living hinges to form a holder;
latching together the side members;
inserting a portion of the impact sensitive item into the holder; and
inserting the holder and the impact sensitive item into a container.

17. The method of claim 16 further comprising the step of placing a second holder around the impact sensitive item.

18. The method of claim 16 further comprising the step of, after forming of the deformable material is completed, stacking together a multiplicity of the deformable materials.
